(19) United States
(12) Patent Application Publication
(10) Pub. No.: US 2025/0364800 A1
(43) Pub. Date: Nov. 27, 2025

(54) SWITCH SHUT-OFF DEVICE FOR POWER SUPPLY SYSTEM

(71) Applicant: DENSO CORPORATION, Kariya-city (JP)

(72) Inventor: Yoshinori MORITA, Kariya-city (JP)

(73) Assignee: DENSO CORPORATION, Kariya-city (JP)

(21) Appl. No.: 19/295,020

(22) Filed: Aug. 8, 2025

Related U.S. Application Data
(63) Continuation of application No. PCT/JP2024/000791, filed on Jan. 15, 2024.

(30) Foreign Application Priority Data
Feb. 10, 2023 (JP) 2023-019469

(51) Int. Cl. H02H 3/087; B60R 16/023; H02J 1/08; H02J 1/10

(52) U.S. Cl. CPC H02H 3/087; B60R 16/023; H02J 1/086; H02J 1/10

(57) ABSTRACT

A switch shut-off device is applied to a power supply system equipped with a first power source and a second power source connected via an electrical pathway, and a plurality of switches provided in the electrical pathway and connected in series with each other. The switch shut-off device includes a calculation unit configured to acquire an energization current flowing through each of a pair of switches that are adjacent to each other in the electrical pathway, among the plurality of switches, and to calculate a total current that is a sum of the energization currents flowing to an intermediate point between the pair of switches, and a shut-off unit configured to shut off the pair of switches when the total current exceeds a threshold current.

### CROSS-REFERENCE TO RELATED APPLICATION

This application is a continuation application of International Application No. PCT/JP2024/000791 filed Jan. 15, 2024 which designated the U.S. and claims priority to Japanese Patent Application No. 2023-019469 filed Feb. 10, 2023, the contents of each of which are incorporated herein by reference.

### BACKGROUND

### Technical Field

The present disclosure relates to a switch shut-off device for a power supply system.

### Related Art

Conventionally, a power supply system including a plurality of power sources, each of which is capable of supplying electric power to electrical loads, has been known. For example, a switch shut-off device applicable to such a known power supply system is configured to determine whether an abnormality has occurred in which an output current of one of the plurality of power sources becomes excessively large, and to shut off a switch based on the determination. Specifically, the switch shut-off device acquires an energization current flowing through the switch and determines that an abnormality has occurred when the acquired energization current exceeds a threshold current. Shutting off the switch through which a energization current exceeding the threshold current flows can inhibit occurrence of an overcurrent in the power supply system.

### BRIEF DESCRIPTION OF THE DRAWINGS

In the accompanying drawings:

FIG. 1 is a schematic diagram of the overall configuration of an on-board power supply system according to a first embodiment;

FIG. 2 is an illustration for explaining issues with a conventional technology;

FIG. 3 is an illustration for explaining issues with a conventional technology;

FIG. 4 is a schematic diagram of a switch shut-off device;

FIG. 5 is a schematic diagram of the configuration of a shut-off circuit;

FIG. 6 is a schematic diagram illustrating a current detection function of a switch;

FIG. 7 is a flowchart illustrating a switch shut-off procedure performed by the shut-off circuit;

FIG. 8 is a schematic diagram of the overall configuration of an on-board power supply system according to a second embodiment; and

FIGS. 9A-9D are diagrams illustrating an example of switch shut-off performed by a shut-off circuit and a pathway breaker circuit.

### DESCRIPTION OF SPECIFIC EMBODIMENTS

In the electrical pathway of a known power supply system, as disclosed in JP 2019-62727 A, the energization current increases when a ground fault occurs between a first power source and a second power source, or when an overcurrent abnormality arises due to a runaway of an electrical load. In such a case, the conventional technology performs switch shut-off based on the magnitude of the current flowing from one of the power sources, which raises a concern about reliability. For example, when a ground fault occurs in the electrical pathway of the power supply system, the supply current from one of the power sources increases due to the ground fault. However, if the increase in current is slight, there is a concern that appropriate switch shut-off in response to the ground fault may not be performed.

In view of the foregoing, it is desired to have a switch shut-off device capable of appropriately performing switch shut-off in the event of an overcurrent abnormality occurring in an electrical pathway.

One aspect of the present disclosure provides a switch shut-off device for a power supply system equipped with a first power source and a second power source connected via an electrical pathway, and a plurality of switches provided in the electrical pathway and connected in series with each other. The switch shut-off device includes a calculation unit configured to acquire an energization current flowing through each of a pair of switches that are adjacent to each other in the electrical pathway, among the plurality of switches, and to calculate a total current that is a sum of the energization currents flowing to an intermediate point between the pair of switches, and a shut-off unit configured to shut off the pair of switches when the total current exceeds a threshold current.

In the power supply system having the above-described configuration, a plurality of switches are provided in an electrical pathway between a first power source and a second power source, and are connected in series with each other. In such a power supply system, for example, when an overcurrent abnormality due to a ground fault or the like occurs between the first power source and the second power source, it is a concern that monitoring only the energization current flowing through any one of the switches may not allow accurate detection of the current increase caused by the ground fault or the like, making it difficult to properly perform switch shut-off in response to the overcurrent abnormality.

According to the present disclosure, the energization current flowing through each of the pair of switches, which are adjacent to each other in the electrical pathway, is acquired, and based on these currents, the total current flowing to the intermediate point between the pair of switches is calculated. Then, when the total current exceeds the threshold current, the pair of switches are shut off. In this case, when an overcurrent abnormality such as a ground fault occurs between the pair of switches, the current flowing from the first power source and the second power source to the intermediate point via the pair of switches respectively increases. That is, the total current reflects both a variation in current flowing from the first power source to the intermediate point via the switch on the first power source side of the pair, and a variation in current flowing from the second power source to the intermediate point via the switch on the second power source side of the pair. Therefore, a current increase at the time of occurrence of an abnormality can be correctly determined based on the total current. This can improve the reliability of abnormality determination and allows switch shut-off to be performed appropriately when an overcurrent abnormality occurs in the electrical pathway.

### First Embodiment

Hereinafter, a switch shut-off device according to a first embodiment of the present disclosure will now be described with reference to the accompanying drawings. In the present embodiment, the switch shut-off device is applied to an on-board power supply system for a vehicle. The power supply system is mounted to a motorized vehicle with a motor as a prime mover.

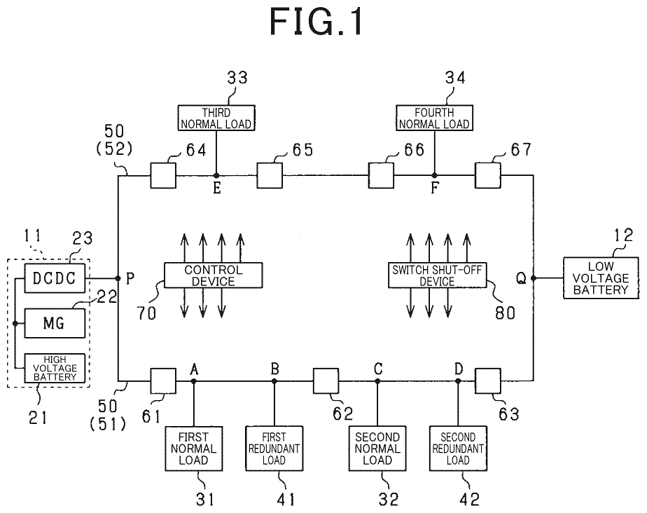

As illustrated in FIG. 1, the power supply system includes a first power source 11 and a second power source 12, which are connected to each other via electrical pathways 50. The first power source 11 includes a high voltage battery 21, a rotating electric machine 22, and a DC-DC converter 23. The high voltage battery 21 is configured as a series connection of a plurality of battery cells, and has a rated voltage of, for example, several hundred volts. Each of the battery cells is a rechargeable battery, and specifically, a rechargeable lithium-ion battery.

The rotating electric machine 22 serves as a prime mover for the vehicle, and is supplied with electric power from the high voltage battery 21 to transmit drive force to drive wheels of the vehicle. The rotating electric machine 22 also functions as a generator that performs regenerative power generation during travel of the vehicle. The rotating electric machine 22 includes an inverter that controls current for each phase, and the inverter is connected to the high voltage battery 21. Accordingly, electric conduction between the high voltage battery 21 and the rotating electric machine 22 is enabled. The DC-DC converter 23 is connected to the high voltage battery 21, and is configured to step down the high voltage on the high voltage battery 21 side.

The second power source 12 includes a low voltage battery that is a rechargeable battery. The low voltage battery is a lead-acid battery or a rechargeable lithium-ion battery. The rated voltage of the low voltage battery is lower than that of the high voltage battery 21 and is, for example, 12 V. The output voltage of the first power source 11 is substantially the same as that of the second power source 12. However, in the present embodiment, the output voltage of the first power source 11 is set slightly higher than the terminal voltage of the second power source 12.

The electrical pathway 50 includes a first pathway 51 and a second pathway 52 as parallel pathways that are arranged in parallel with each other. The electrical pathway 50 is branched into two branches between a branch point P on the first power source 11 side and a branch point Q on the second power source 12 side, whereby the first pathway 51 and the second pathway 52 are connected in parallel.

The power supply system includes, as electrical loads, first to fourth normal loads 31 to 34 and first and second redundant loads 41 and 42. Each of the loads 31 to 34 and 41 and 42 is configured to receive power from both the first power source 11 and the second power source 12. Each of the normal loads 31 to 34 is, for example, an electrical load that is not used for driving assistance control of the vehicle, and specifically includes components such as an air conditioner, an audio device, power windows, an electric fan for a radiator that cools engine coolant, stop lamps, interior lights, a USB power socket, and motors for driving mirrors provided outside the cabin.

The redundant loads 41 and 42 are configured such that a specific function can be implemented by each or either of the redundant loads. This can prevent the entire function from being lost even when an abnormality occurs in either one of the redundant loads 41 and 42. The redundant loads 41 and 42 are, for example, electrical loads used for driving assistance control of the vehicle, and specifically include an electric power steering system that generates assist torque to assist the driver's steering, an electric brake system that applies braking force to the wheels, cameras, laser radar such as Laser Imaging Detection and Ranging (LiDAR), millimeter-wave radar for monitoring surroundings of the vehicle, and by-wire systems.

A specific function may be realized by combining devices of different types as the redundant loads 41 and 42. For example, the first redundant load 41 may be LIDAR and the second redundant load 42 may be a camera, as loads used for monitoring the front of the vehicle.

The first pathway 51 is connected to first and second normal loads 31 and 32 and first and second redundant loads 41 and 42. The normal loads 31 and 32 and the redundant loads 41 and 42 are respectively connected to connection points A, B, C, and D along the first pathway 51. The second pathway 52 is connected to third and fourth normal loads 33 and 34. The normal loads 33 and 34 are respectively connected to connection points E and F along the second pathway 52. Each of the loads 31 to 34 and 41 and 42 has a positive terminal side connected to the corresponding pathway 51 or 52 and a negative terminal side connected to a grounded portion such as a vehicle body. It should be noted that each of the loads 31 to 34 and 41 and 42 illustrated in FIG. 1 may be a single electrical load or may include a plurality of electrical loads.

The power supply system includes first to seventh switches 61 to 67. Each of the switches 61 to 67 is configured with, for example, a relay or a semiconductor switch such as a MOSFET. The first switch 61 is provided in the first pathway 51 between the branch point P and the connection point A of the first normal load 31. The second switch 62 is provided in the first pathway 51 between the connection point B of the first redundant load 41 and the connection point C of the second normal load 32. The third switch 63 is provided in the first pathway 51 between the connection point D of the second redundant load 42 and the branch point Q.

The fourth switch 64 is provided in the second pathway 52 between the branch point P and the connection point E of the third normal load 33. The fifth and sixth switches 65 and 66 are provided in the second pathway 52 between the connection point E of the third normal load 33 and the connection point F of the fourth normal load 34. The seventh switch 67 is provided in the second pathway 52 between the connection point F of the fourth normal load 34 and the branch point Q.

The power supply system includes a control device 70 that controls the turn-on and turn-off of each of the switches 61 to 67. The control device 70 is mainly constituted by a microcomputer including a CPU and various types of memory. The control device 70 turns on the switches 61 to 67 in response to, for example, the turn-on of a vehicle start switch, and turns them off in response to the turn-off of the vehicle start switch.

The power supply system includes a switch shut-off device 80 that, when an overcurrent abnormality occurs in which an excessive current flows through the first or second pathway 51 or 52, shuts off a switch corresponding to the location of the abnormality among the switches 61 to 67. This can inhibit occurrence of overcurrent in the power supply system. The overcurrent abnormality may be caused by a ground fault in which a portion of the electrical pathway is short-circuited to a grounded portion, or by a runaway of an electrical load.

Incidentally, in the electrical pathway 50 of the power supply system including two power sources 11 and 12, when an overcurrent abnormality occurs, the energization current in the electrical pathway 50 increases. According to the conventional technique, however, switch shut-off is performed based on the magnitude of the current flowing from one of the power sources, which raises concerns about low reliability.

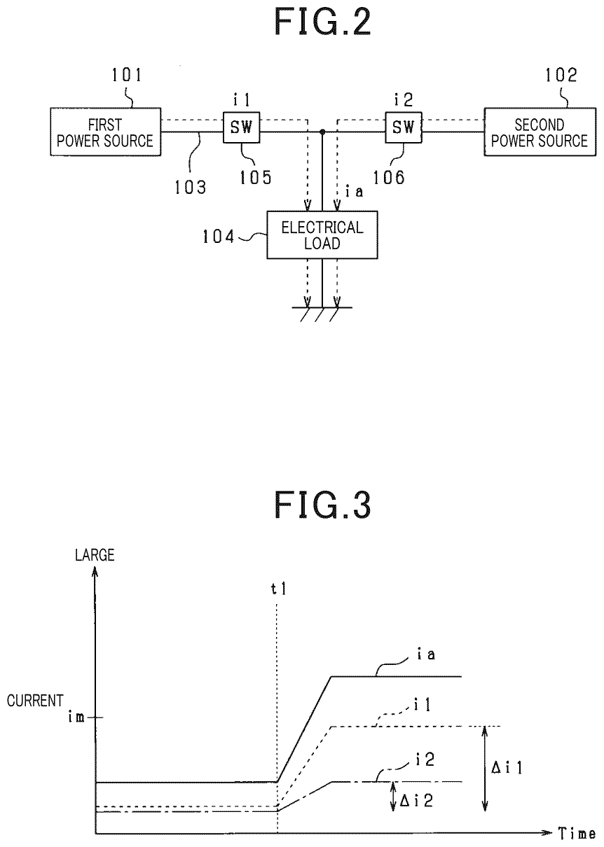

Issues with the conventional technology will now be described with reference to the configuration illustrated in FIG. 2. The power supply system includes a first power source 101 and a second power source 102, an electrical load 104 connected to an electrical pathway 103 that connects the first power source 101 and the second power source 102, and switches 105 and 106 that are respectively provided on the first power source 101 side and the second power source 102 side of the connection point of the electrical load 104 in the electrical pathway 103. The electrical load 104 is supplied with current from both the first power source 101 and the second power source 102. In FIG. 2, the output current of the first power source 101 is indicated as i1, the output current of the second power source 102 is indicated as i2, and the supply current supplied to the electrical load 104 from the power sources 101 and 102 is indicated as ia.

FIG. 3 illustrates transitions of the output currents i1 and i2 and the supply current ia in a case where a ground fault occurs in the electrical load 104. When a ground fault occurs at time t1, the current flowing through the electrical load 104 increases. As a result, the supply current ia increases and exceeds an upper limit value im of the current that flows through the electrical load 104 in the absence of a ground fault. However, when the leakage current caused by the ground fault is relatively small, that is, when the ground fault is relatively minor, the supply current ia may exceed the upper limit value im, but the increases Δi1 and Δi2 in the output currents i1 and i2, respectively, may be too small to be determined as indicating a ground fault. In such a case, in the conventional technology in which the presence or absence of a ground fault is determined based on the energization current flowing through only one of the switches 105 or 106, there is a concern that the reliability of the switch shut-off may be reduced.

In view of the foregoing, the power supply system is equipped with a switch shut-off device 80. The switch shut-off device 80 includes a calculation unit configured to acquire the energization current flowing through each of a pair of adjacent switches in the electrical pathway 50, and to calculate a total current, which is the sum of the currents flowing to an intermediate point between the pair of switches, based on the acquired energization currents; and a shut-off unit configured to shut off the pair of switches when the total current exceeds a threshold current.

In the present embodiment, in each of the pathways 51 and 52, two adjacent switches constitute a pair of switches. A pair of switches is provided for each electrical load, with the electrical load disposed between them. Specifically, in the first pathway 51, the first and second switches 61 and 62 on both sides of the pair of connection points A and B, and the second and third switches 62 and 63 on both sides of the pair of connection points C and D, respectively constitute pairs of switches. In this case, in the first pathway 51, the first and second switches 61 and 62, which are positioned to sandwich only the first connection point B (hereinafter referred to as the first connection point), to which the first redundant load 41 is connected, constitute one pair of switches; and the second and third switches 62 and 63, which are positioned to sandwich only the second connection point D (hereinafter referred to as the second connection point), to which the second redundant load 42 is connected, constitute another pair of switches. In the second pathway 52, the fourth and fifth switches 64 and 65 are provided on both sides of the connection point E, and the sixth and seventh switches 66 and 67 are provided on both sides of the connection point F.

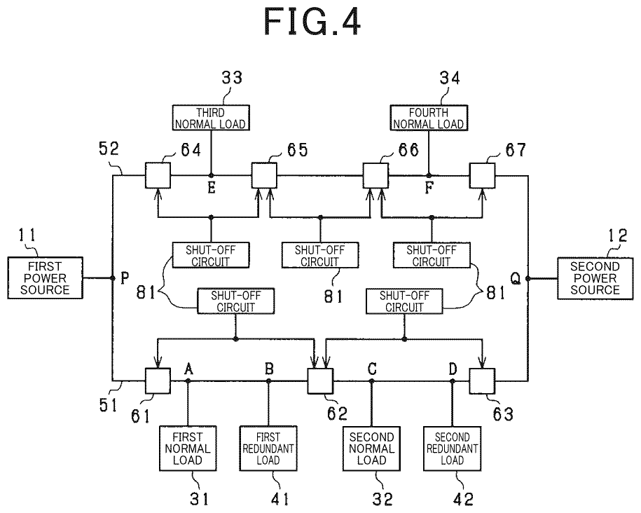

As illustrated in FIG. 4, the switch shut-off device 80 includes a shut-off circuit 81 for each pair of switches. That is,
a pair of switches formed by the combination of a first switch 61 and a second switch 62;
a pair of switches formed by the combination of a second switch 62 and a third switch 63;
a pair of switches formed by the combination of a fourth switch 64 and a fifth switch 65; and
a pair of switches formed by the combination of a sixth switch 66 and a seventh switch 67, are provided with respective shut-off circuits 81. Each of these shut-off circuits 81 has a function of calculating a total current of the corresponding pair of switches in response to occurrence of a ground fault and shutting off the pair of switches based on the total current.

In FIG. 4, in consideration of a potential ground fault occurring in the wiring portion between the fifth switch 65 and the sixth switch 66, a shut-off circuit 81 is also provided for the pair of switches formed by the combination of the fifth switch 65 and the sixth switch 66.

With reference to FIG. 5, the configuration of the shut-off circuits 81 respectively provided for the pair of switches consisting of the first and second switches 61 and 62, and the pair of switches consisting of the second and third switches 62 and 63 in the first pathway 51 will be described. Here, the shut-off circuit 81 for the first and second switches 61 and 62 is referred to as a shut-off circuit 81A, and the shut-off circuit 81 for the second and third switches 62 and 63 is referred to as a shut-off circuit 81B.

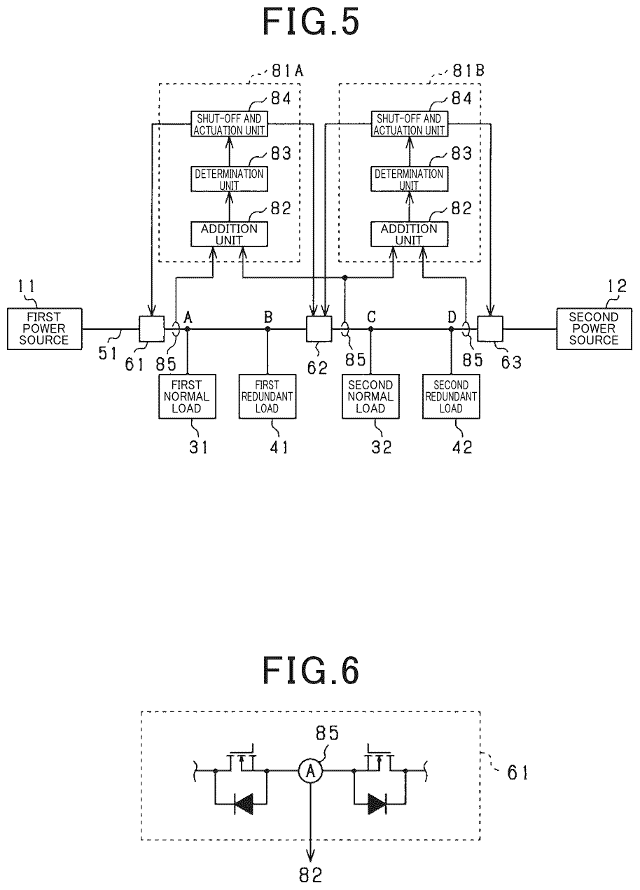

A current sensor 85 is provided for each of the first to third switches 61 to 63. Each switch and its corresponding current sensor 85 may have the following configuration. As illustrated in FIG. 6, the first switch 61 is formed by two N-channel MOSFETs whose source terminals are connected to each other. A current sensor 85 is provided between the sources of the two N-channel MOSFETs. The current sensor 85 detects current using, for example, a shunt resistor or a Hall element. The second to seventh switches 62 to 67 also have the similar configuration.

As illustrated in FIG. 5, the shut-off circuit 81A includes an addition unit 82, a determination unit 83, and a shut-off and actuation unit 84. The addition unit 82 acquires energization currents flowing through the first and second switches 61 and 62, respectively. Specifically, the addition unit 82 acquires a detection value of the current sensor 85 for the first switch 61 as the energization current flowing through the first switch 61, and acquires a detection value of the current sensor 85 for the second switch 62 as the energization current flowing through the second switch 62.

The addition unit 82 calculates a total current Is, which is a sum of currents flowing to an intermediate point (connection points A and B) between the first and second switches 61 and 62, based on the energization currents flowing through the first and second switches 61 and 62. In this case, the addition unit 82 calculates the total current Is by treating the direction of discharge current flowing from the first power source 11 through the first switch 61 as positive, and also treating the direction of discharge current flowing from the second power source 12 through the second switch 62 as positive. The total current Is calculated by the addition unit 82 is input to the determination unit 83. The addition unit 82 may be configured, for example, using an operational amplifier.

The determination unit 83 determines whether the total current Is calculated by the addition unit 82 exceeds a threshold current. When the determination unit 83 determines that the total current Is calculated by the addition unit 82 exceeds the threshold current, it determines that an overcurrent abnormality has occurred between the first and second switches 61 and 62 in the first pathway 51, and switches the logic of a shut-off signal Sg from LOW to HIGH. The shut-off signal Sg is a signal that, when at logic LOW, instructs the shut-off and actuation unit 84 to maintain the conductive states of the first and second switches 61 and 62, and when at logic HIGH, instructs the shut-off and actuation unit 84 to shut off the first and second switches 61 and 62. The determination unit 83 is configured using, for example, an operational amplifier.

The shut-off and actuation unit 84 maintains the conductive states of the first and second switches 61 and 62 when the shut-off signal Sg at logic LOW is input. On the other hand, the shut-off and actuation unit 84 shuts off the first and second switches 61 and 62 when the shut-off signal Sg at logic HIGH is input. As a result, the overcurrent abnormality location is electrically disconnected from the first power source 11 and the second power source 12. The addition unit 82 corresponds to a calculation unit, and the determination unit 83 and the shut-off and actuation unit 84 correspond to a shut-off unit. The shut-off circuit 81B has the same configuration as the shut-off circuit 81A.

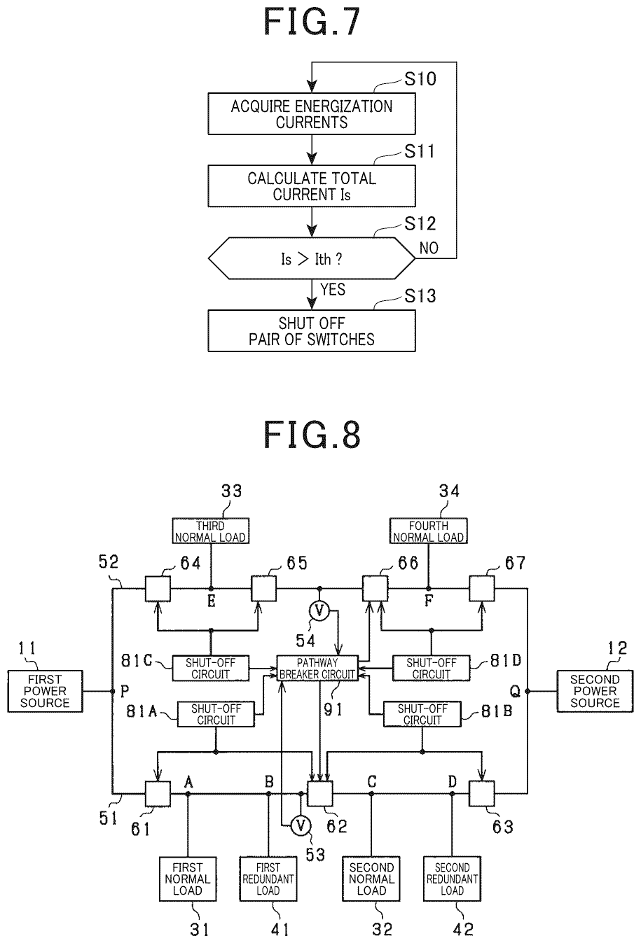

FIG. 7 illustrates a switch shut-off procedure performed by each shut-off circuit 81. Here, as an example, the switch shut-off procedure performed by the shut-off circuit 81A illustrated in FIG. 5 will be described.

In the shut-off circuit 81A, the addition unit 82 acquires the energization currents respectively flowing through the first and second switches 61 and 62, and based on the energization currents, calculates a total current Is that flows to an intermediate point (connection points A and B) between the first and second switches 61 and 62 (steps S10 and S11).

The determination unit 83 determines whether the total current Is through the first and second switches 61 and 62 exceeds a threshold current Ith (at step S12). The threshold current Ith is set to a value greater than the upper limit current when actuating the electrical loads connected between the first and second switches 61 and 62. In the configuration in which the first normal load 31 and the first redundant load 41 are connected between the first and second switches 61 and 62, the threshold current Ith may be equal to or greater than the value obtained by summing the respective upper limit values of actuation currents to the loads 31 and 41. When only one of the first and second switches 61 and 62 is in the actuated state, the threshold current Ith may be set to a value equal to or greater than the upper limit value of the actuation current of the load in the actuated state.

When the determination unit 83 determines that the total current Is through the first and second switches 61 and 62 is equal to or less than the threshold current Ith, the shut-off signal Sg remains at logic LOW. In this case, the shut-off and actuation unit 84 maintains the current ON/OFF states of the first and second switches 61 and 62. On the other hand, when the determination unit 83 determines that the total current Is through the first and second switches 61 and 62 exceeds the threshold current Ith, the determination unit 83 outputs the shut-off signal Sg at logic HIGH. In this case, the shut-off and actuation unit 84 shuts off the first and second switches 61 and 62 (at step S13).

The above-described processing performed by the shut-off circuit 81A is performed in parallel and similarly in the other shut-off circuits 81 of the switch shut-off device 80. Accordingly, even when an overcurrent abnormality due to a ground fault or the like occurs in any of the electrical loads in the electrical pathway(s) 50, appropriate switch shut-off can be performed according to where the abnormality has occurred.

The present embodiment, as detailed above, can provide the following advantages.

The energization current flowing through each of a pair of switches, which are adjacent to each other in the electrical pathway 50, is acquired, and based on these currents, a total current Is flowing to the intermediate point between the pair of switches is calculated. Then, when the total current Is exceeds the threshold current Ith, the pair of switches are shut off. In this case, when an overcurrent abnormality such as a ground fault occurs between the pair of switches, the current flowing from the first power source 11 and the second power source 12 to the intermediate point via the pair of switches respectively increases. That is, the total current reflects both a variation in current flowing from the first power source 11 to the intermediate point via the switch on the first power source 11 side of the pair, and a variation in current flowing from the second power source 12 to the intermediate point via the switch on the second power source 12 side of the pair. Therefore, a current increase at the time of occurrence of an abnormality can be correctly determined based on the total current Is. This can improve the reliability of abnormality determination and allows switch shut-off to be performed appropriately when an overcurrent abnormality occurs in the electrical pathway.

For each pair of switches arranged adjacent to each other in the electrical pathway 50, a total current of currents flowing through the respective switches of the pair is calculated, and the switches of the pair on both sides of the intermediate point are shut off based on the total current. Such an abnormality determination based on the total current enables identification of the location of the abnormality, allowing only the location of the abnormality to be disconnected from the first power source 11 and the second power source 12. As a result, power can continue to be supplied from the first power source 11 and the second power source 12 to the electrical loads connected to locations other than where the abnormality has occurred.

The threshold current Ith is set to a value greater than the upper limit of the actuation current required to actuate the electrical loads connected between the pair of switches. This can inhibit occurrence of an erroneous determination that an abnormality has occurred when the total current Is exceeds the threshold current It during use of the electrical loads.

In the first pathway 51, the first and second switches 61 and 62, which are positioned to sandwich only the connection point B to which the first redundant load 41 is connected, constitute one pair of switches; and the second and third switches 62 and 63, which are positioned to sandwich only the connection point D to which the second redundant load 42 is connected, constitute another pair of switches. This allows the functions implemented by any of the redundant loads 41 and 42 to be maintained even when one of the pairs of switches are shut off.

In the above configuration, the first to third switches 61 to 63 are provided in the first pathway 51, and the fourth to seventh switches 64 to 67 are provided in the second pathway 52. The first pathway 51 and the second pathway 52 are provided in parallel with each other. In this case, when an overcurrent abnormality occurs in either the first pathway 51 or the second pathway 52, and the location of the abnormality is disconnected from both the first power source 11 and the second power source 12, power can continue to be supplied from both the first and second power sources through the pathway in which the abnormality has not occurred.

### Second Embodiment

In the present embodiment, the configuration of the switch shut-off device 80 is modified. In the power supply system, when an overcurrent abnormality caused by a ground fault or the like occurs at any point on the electrical pathway 50, a voltage drop occurs on the electrical pathway 50, which hinders the power supply to each electrical load from both the first power source 11 and the second power source 12. Accordingly, in the present embodiment, the voltage of the electrical pathway 50 is acquired as a pathway voltage, and when the pathway voltage falls below a threshold voltage, the electrical pathway 50 is disconnected between the first power source 11 side and the second power source 12 side.

FIG. 8 is a schematic diagram illustrating the configuration of the power supply system according to the present embodiment. Similar to FIG. 4, the switch shut-off device 80 includes a shut-off circuit 81 for each pair of switches arranged in the electrical pathway 50. Here, the four shut-off circuits 81 are designated as shut-off circuits 81A, 81B, 81C, and 81D, respectively. In the present embodiment, the shut-off circuits 81A to 81D correspond to a first shut-off unit.

In addition, in the power supply system illustrated in FIG. 8, a distinguishing feature from FIG. 4 is that voltage sensors 53 and 54 are provided in the first pathway 51 and the second pathway 52, respectively. The voltage sensor 53 is provided, for example, in the vicinity of the second switch 62 in the first pathway 51, and detects the voltage of the first pathway 51. The voltage sensor 54 is provided, for example, in the vicinity of the sixth switch 66 in the second pathway 52, and detects the voltage of the second pathway 52.

The switch shut-off device 80 includes a pathway breaker circuit 91 configured to disconnect each of the first pathway 51 and the second pathway 52 between the first power source 11 side and the second power source 12 side, based on the voltages detected by voltage sensors 53 and 54. In the present embodiment, the second switch 62 disposed between two adjacent connection points B and C in the first pathway 51 and the sixth switch 66 disposed between two adjacent connection points E and F in the second pathway 52 are employed as inter-load switches. In the first pathway 51, the second switch 62 disposed between the two redundant loads 41 and 42 configured to implement the same function serves as the inter-load switch.

The pathway breaker circuit 91 acquires, as pathway voltages, the detected voltages from the voltage sensors 53 and 54, respectively. When at least one of the pathway voltages falls below a threshold voltage, the pathway breaker circuit 91 shuts off the inter-load switches (switches 62 and 66), thereby breaking each of the first pathway 51 and the second pathway 52 between the first power source 11 side and the second power source 12 side. The threshold voltage is set, for example, to the highest voltage among the voltages at which the loads 31 to 34 and 41, 42 can operate. The pathway breaker circuit 91, like the shut-off circuits 81, is constituted by a hardware-based electronic circuit.

In the first pathway 51, the first redundant load 41 and the second normal load 32, which are connected to the connection points B and C, respectively correspond to a first electrical load and a second electrical load. In the second pathway 52, the third normal load 33 and the fourth normal load 34, which are connected to the connection points E and F, respectively correspond to a first electrical load and a second electrical load. In the second pathway 52, the fifth switch 65 may be used as the inter-load switch instead of the sixth switch 66. In the present embodiment, the pathway breaker circuit 91 corresponds to a second shut-off unit.

When an overcurrent abnormality occurs in the power supply system due to a ground fault or the like, the electrical pathway 50 is broken into two portions by the shut-off of the second and sixth switches 62 and 66. In one of the two portions of the electrical pathway 50, power is supplied from the first power source 11 to the first and third normal loads 31 and 33 and to the first redundant load 41. In the other portion, power is supplied from the second power source 12 to the second and fourth normal loads 32 and 34 and to the second redundant load 42. Accordingly, even when a voltage drop occurs in the electrical pathway 50 due to a ground fault, total power loss in all electrical loads is suppressed, allowing some of the electrical loads to continue operating.

The shut-off of the pair of switches by each shut-off circuit 81 and the shut-off of the inter-load switches (the second and sixth switches 62 and 66) by the pathway breaker circuit 91 are performed in parallel. When an overcurrent abnormality occurs, a voltage change in the electrical pathway 50 may occur before a change in the current flowing through the switches 61 to 67, due to the inductance component of the electrical pathway. In some cases, it is preferable to detect a change in the current flowing through the electrical pathway 50 using the voltage sensors 53 and 54, rather than the current sensors for the switches 61 to 67. In this respect, in the present embodiment, the pathway breaker circuit 91 shuts off the second and sixth switches 62 and 66 in response to a voltage change in the electrical pathway 50, thereby enabling rapid switch shut-off in the event of occurrence of an overcurrent abnormality.

When the electrical pathway 50 is broken into two portions on the first power source 11 side and the second power source 12 side due to occurrence of an overcurrent abnormality, an overcurrent continues to flow through the electrical pathway 50 on the side where the overcurrent abnormality has occurred, either the first power source 11 side or the second power source 12 side. Accordingly, when the total current flowing through a pair of switches, among the pairs of switches that are subject to shut-off, exceeds a threshold current, that pair of switches are shut off.

Here, in a case where, following shut-off of the inter-load switches by the pathway breaker circuit 91 due to a voltage drop in the electrical pathway 50 caused by a ground fault or the like, a pair of switches are further shut off by the corresponding shut-off circuit 81 according to the total current flowing through that pair of switches, a situation may arise in which both the second and sixth switches 62 and 66 are unnecessarily shut off by the pathway breaker circuit 91.

For example, when a ground fault occurs in the third normal load 33 on the second pathway 52 side, the inter-load switches (second and sixth switches 62 and 66) are shut off by the pathway breaker circuit 91, and subsequently, the fourth and fifth switches 64 and 65 are shut off by the shut-off circuit 81C. In this case, if the inter-load switches (second and sixth switches 62 and 66) remain in the off state, the power supply from the first power source 11 and the second power source 12 to the loads 31, 32, 41, and 42 on the first pathway 51 side, which has not experienced a short circuit, will be unnecessarily restricted.

In view of the foregoing, in the present embodiment, when the inter-load switches (i.e., the second and sixth switches 62 and 66) are shut off by the pathway breaker circuit 91, and in addition, a pair of switches are shut off by the corresponding shut-off circuit 81, the configuration is such that any switch that is subject to shut-off by the pathway breaker circuit 91 but not by the shut-off circuit 81 is restored to the conductive state.

Specifically, when the inter-load switches, namely the second and sixth switches 62 and 66, are shut off, the pathway breaker circuit 91 restores at least one of the second switch 62 and the sixth switch 66 to the conductive state, according to the logic of the shut-off signal Sg input from each shut-off circuit 81. In the present embodiment, the pathway breaker circuit 91 corresponds to a restoration unit.

When the inter-load switches (i.e., the second and sixth switches 62 and 66) have been shut off, and a shut-off signal Sg having the logic HI (i.e., a signal indicating to shut off the switch) is input from a shut-off circuit 81, the pathway breaker circuit 91 restores the inter-load switch in the pathway opposite to the pathway from which the shut-off signal was input to the pathway breaker circuit 91 among the two pathways 51 and 52 to the conductive state. Further, when the inter-load switches (i.e., the second and sixth switches 62 and 66) have been shut off, and a shut-off signal Sg having the logic HI is input from a shut-off circuit 81, the pathway breaker circuit 91 restores to the conductive state the inter-load switch in the same pathway as the pathway from which that shut-off signal was input to the pathway breaker circuit 91 among the two pathways 51 and 52, provided that that inter-load switch subject to shut-off by the pathway breaker circuit 91 but not by that shut-off circuit 81.

More specifically, the pathway breaker circuit 91 selectively restores each of the inter-load switches (the second and sixth switches 62 and 66) to the conductive state as follows:
When the shut-off signal Sg having the logic HI is acquired from the shut-off circuit 81A, the sixth switch 66 is restored to the conductive state.
When the shut-off signal Sg having the logic HI is acquired from the shut-off circuit 81B, the sixth switch 66 is restored to the conductive state.
When the shut-off signal Sg having the logic HI is acquired from the shut-off circuit 81C, the second and sixth switches 62 and 66 are restored to the conductive state.
When the shut-off signal Sg having the logic HI is acquired from the shut-off circuit 81D, the second switch 62 is restored to the conductive state.

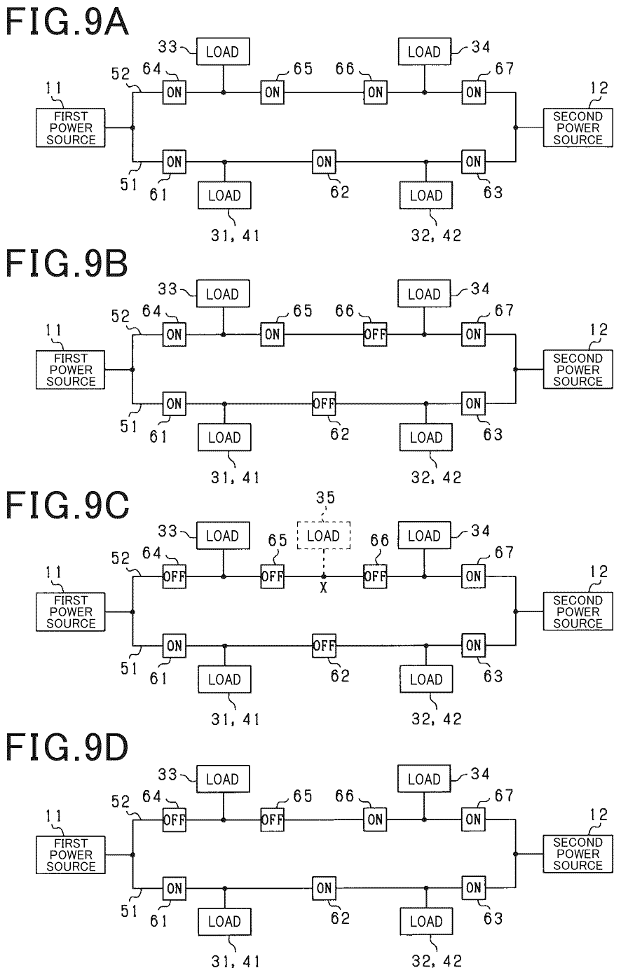

FIGS. 9A-9D illustrate an example of a switch shut-off operation performed by each shut-off circuit 81 and the pathway breaker circuit 91. Here, a case will be described in which, as illustrated in FIG. 9A, a ground fault occurs in the third normal load 33 while all the switches 61 to 67 are in the ON state.

After occurrence of a ground fault in the third normal load 33, when the pathway voltage of the second pathway 52 decreases and falls below a threshold voltage, the inter-load switches, namely the second and sixth switches 62 and 66, are shut off, as illustrated in FIG. 9B. As a result, each of the first pathway 51 and the second pathway 52 is broken into portions on the first power source 11 side and the second power source 12 side.

Due to the occurrence of a ground fault in the third normal load 33, the total current flowing through the pair of switches corresponding to the third normal load 33, namely the fourth and fifth switches 64 and 65, increases. Accordingly, when the total current through the fourth and fifth switches 64 and 65 exceeds the threshold current, the fourth and fifth switches 64 and 65 are shut off, as illustrated in FIG. 9C.

In FIG. 9C, the inter-load switches, namely the second and sixth switches 62 and 66, are shut off, and the second and sixth switches 62 and 66 are not subject to shut-off by the shut-off circuits 81. Accordingly, as illustrated in FIG. 9D, the second and sixth switches 62 and 66 are restored to the conductive state.

In this case, in the state illustrated in FIG. 9C, although the actual ground fault in the second pathway 52 is isolated by the fourth and fifth switches 64 and 65, the second and sixth switches 62 and 66 are also in the OFF state. In this state, power supply from the first power source 11 and the second power source 12 to the loads 31, 32, 41, and 42 on the first pathway 51, which is on the side where no short circuit has occurred, is unnecessarily restricted. As illustrated in FIG. 9D, when the second switch 62 is restored to the conductive state, the unnecessary restriction on power supply in the first pathway 51 is eliminated.

In the state illustrated in FIG. 9C, since the fourth and fifth switches 64 and 65 as well as the sixth switch 66 are in the OFF state in the second electrical pathway 52, if an electrical load 35 is connected to the connection point X between the fifth and sixth switches 65 and 66, power supply to the electrical load 35 is unnecessarily shut off. In this regard, as illustrated in FIG. 9D, restoring the sixth switch 66 to the conductive state minimizes the length of the pathway where the power supply is shut off, thereby eliminating unnecessary power shut-offs.

In the present embodiment described in detail above, the configuration is such that when the pathway voltage of an electrical pathway 50 falls below a threshold voltage, the inter-load switch is shut off, thereby breaking the electrical pathway 50 into portions on the first power source 11 side and the second power source 12 side. This can prevent a power supply failure from occurring throughout the entire electrical pathway 50 by disconnecting the first power source 11 side and the second power source 12 side in the event of an overcurrent abnormality caused by a ground fault or the like at any location on the electrical pathway 50.

The configuration is such that the inter-load switch is provided at a position between the first redundant load 41 and the second redundant load 42 in the electrical pathway 50. This configuration allows the functions implemented by the respective redundant loads 41 and 42 to continue immediately after the inter-load switch is shut off due to a drop in the pathway voltage.

In a case where the inter-load switch is shut off by the pathway breaker circuit 91 and a pair of switches are shut off by the shut-off circuit 81, the configuration is such that any switch, among the plurality of switches, that is subject to shut-off by the pathway breaker circuit 91 (i.e., an inter-load switch) but not by the shut-off circuit 81 is restored to the conductive state. This configuration can prevent any of the switches 61 to 67 provided in the electrical pathway 50 from remaining unnecessarily in the OFF state.

### Other Embodiments

Each of the above embodiments may be modified as follows.
The shut-off circuits 81 of the switch shut-off device 80 may implement various functions, at least in part, by software, that is, by processes performed on a computer, instead of implementing the functions by hardware-based electronic circuits. Specifically, the control device 70 illustrated in FIG. 1 may implement the functions of the shut-off circuits 81. The control device 70 executes a program stored in a non-transitory tangible storage medium as a storage unit incorporated in the control device 70. The program includes, for example, a program corresponding to the process flow illustrated in FIG. 7. The method corresponding to the program is performed by executing the program. The storage unit is, for example, a non-volatile memory. The program stored in the storage unit may be updated via a network such as the Internet. In the present embodiment, the processes at steps S10 and S11 correspond to a calculation unit, and the processes at steps S12 and S14 correspond to a shut-off unit.

When the shut-off unit (as a function of the shut-off circuit 81) that shuts off a pair of switches based on the total current flowing through the pair of switches is implemented by computer software processing, the switch shut-off becomes a discrete process, which raises a concern about a delay in the switch shut-off operation. In this respect, the combination with the pathway breaker circuit 91 as described in the second embodiment makes it possible to respond immediately to a ground fault or the like by shutting off the inter-load switch in response to the pathway voltage, while also enabling appropriate switch shut-off based on identification of where the abnormality has occurred.
As the threshold current Ith at step S12 of FIG. 7, a value that is set independently of the upper limit current for actuating the electric loads connected between the pair of switches may be used. For example, in the shut-off process performed by the shut-off circuit 81 that subjects the fifth and sixth switches 65 and 66 to shut-off, a value equal to or greater than zero may be used as the threshold current Ith.
The configuration of the first power source 11 and the second power source 12 may be modified. For example, both the first power source 11 and the second power source 12 may be low voltage batteries. Alternatively, both the first power source 11 and the second power source 12 may be low voltage batteries, and a generator may be connected to either one of the first power source 11 and the second power source 12.
Each of the switches 61 to 67 may be a normally closed switch, and may be configured to be shut off by the switch shut-off device 80 only when an overcurrent abnormality has occurred.
The power supply system may be mounted to a mobile object other than a vehicle. Alternatively, the power supply system may be a stationary system.
The control device and the method thereof described in the present disclosure may be realized by a dedicated computer provided by configuring a processor and memory programmed to perform one or more functions embodied in a computer program. Alternatively, the control device and the method thereof described in the present disclosure may be realized by a dedicated computer provided by configuring a processor with one or more dedicated hardware logic circuits. Alternatively, the control device and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. A switch shut-off device for a power supply system equipped with a first power source and a second power source connected via an electrical pathway, and a plurality of switches provided in the electrical pathway and connected in series with each other, the switch shut-off device comprising:
a calculation unit configured to acquire an energization current flowing through each of a pair of switches that are adjacent to each other in the electrical pathway, among the plurality of switches, and to calculate a total current that is a sum of the energization currents flowing to an intermediate point between the pair of switches; and
a shut-off unit configured to shut off the pair of switches when the total current exceeds a threshold current.

2. The switch shut-off device according to claim 1, wherein
the power supply system is further equipped with a plurality of electrical loads connected to the electrical pathway at respective connection points, and a plurality of the pairs of switches, the connection point for each of the plurality of electrical loads being sandwiched between a different pair of switches along the electrical pathway,
the calculation unit is configured to calculate the total current flowing to the intermediate point between each pair of switches, and
the shut-off unit is configured to shut off a pair of switches, among the plurality of the pairs of switches, through which the total current exceeds the threshold current.

3. The switch shut-off device according to claim 2, wherein
the threshold current for each of the plurality of electrical loads is a current value greater than an upper limit current for actuating that electrical load.

4. The switch shut-off device according to claim 2, wherein
the plurality of electrical loads include a first redundant load and a second redundant load, and each or either of the first and second redundant loads is capable of implementing a specific function,
the shut-off unit is configured to define, as a first pair of switches, the pair of switches that are arranged along the electrical pathway so as to sandwich only a first connection point at which the first redundant load is connected to the electrical pathway, and to define, as a second pair of switches, the pair of switches that are arranged along the electrical pathway so as to sandwich only a second connection point at which the second redundant load is connected to the electrical pathway, and to shut off a pair of switches among the first and second pairs of switches, through which the total current exceeds the threshold current.

5. The switch shut-off device according to claim 2, wherein
the plurality of electrical loads include a first electrical load and a second electrical load connected to the respective connection points along the electrical pathway,
the plurality of switches include a switch provided between the connection points of the first electrical load and the second electrical load as an inter-load switch,
the shut-off unit is a first shut-off unit, and
the switch shut-off device further comprises a second shut-off unit configured to acquire a voltage of the electrical pathway as a pathway voltage and, when the pathway voltage falls below a threshold voltage, shut off the inter-load switch and break the electrical pathway into portions on the first power supply side and the second power supply side.

6. The switch shut-off device according to claim 5, wherein
the plurality of electrical loads include a first redundant load and a second redundant load, and each or either of the first and second redundant loads is capable of implementing a specific function, and
the inter-load switch is provided at a position between the first redundant load and the second redundant load in the electrical pathway.

7. The switch shut-off device according to claim 5, further comprising:
a restoration unit configured to, when the inter-load switch is shut off by the second shut-off unit and a pair of switches, among the plurality of pairs of switches, are shut off by the first shut-off unit, restore a switch that is subject to shut-off by the second shut-off unit and is not subject to shut-off by the first shut-off unit, among the plurality of switches, to a conductive state.

8. The switch shut-off device according to claim 1, wherein
the electrical pathway comprises a plurality of parallel pathways connected in parallel with each other,
the calculation unit is configured to calculate the total current through the pair of switches in each of the parallel pathways, and
the shut-off unit is configured to shut off a pair of switches through which the total current exceeds the threshold current, among the pairs of switches in the plurality of parallel pathways.

9. A program product comprising:
a non-transitory computer-readable medium;
instructions stored on the non-transitory computer-readable medium that, when executed by a processor, cause the processor to perform a switch shut-off method applied to a power supply system equipped with a first power source and a second power source connected via an electrical pathway, and a plurality of switches provided in the electrical pathway and connected in series with each other, the switch shut-off method comprising:
acquiring an energization current flowing through each of a pair of switches that are adjacent to each other in the electrical pathway, among the plurality of switches, and to calculate a total current that is a sum of the energization currents flowing to an intermediate point between the pair of switches; and
shutting off the pair of switches when the total current exceeds a threshold current.

10. A non-transitory computer-readable medium storing instructions that, when executed by a processor, cause the processor to perform a switch shut-off method applied to a power supply system equipped with a first power source and a second power source connected via an electrical pathway, and a plurality of switches provided in the electrical pathway and connected in series with each other, the switch shut-off method comprising:
acquiring an energization current flowing through each of a pair of switches that are adjacent to each other in the electrical pathway, among the plurality of switches, and to calculate a total current that is a sum of the energization currents flowing to an intermediate point between the pair of switches; and
shutting off the pair of switches when the total current exceeds a threshold current.
